(19) United States
(12) Patent Application Publication
(10) Pub. No.: US 2004/0195713 A1
(43) Pub. Date: Oct. 7, 2004

(54) Method and device for removing the core of water-soluble casting cores

(76) Inventor: Helge Hansel, Bisingen (DE)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/487,558

(22) PCT Filed: Aug. 23, 2002
(86) PCT No.: PCT/EP02/09442

(30) Foreign Application Priority Data
Aug. 24, 2001 (EP) 101 41 633.4

(51) Int. Cl. B29C 39/36

(52) U.S. Cl. 264/37.1; 264/335; 425/436 R

(57) ABSTRACT

In a method for the coring of water-soluble casting cores made from sand, there is a partial dissolving of the cores in a water-filled dissolving tank (1.5). A sand-permeable conveyor belt (1.10) provided with dogs (1.11) for sand discharge purposes conveys the castings (1.9) into a coring tank (1.8), where the sand is ejected by means of water jets from program-controllably movable water jet nozzles (1.13). Residual desanding takes place by targeted movement in a water-filled residual desanding tank (1.6). The old sand (12) collected in the tanks (1.5, 1.6, 1.8) is removed, cleaned in a sand washing device, dried and reused for casting core production. The waste water produced is concentrated in an evaporator unit and reused as secondary raw material. The distillate is available again to the plant.

The invention relates to a method and to a device for coring water-soluble casting cores made from sand.

The removal of the casting cores from the finished casting, also known as coring or decoring, in the case of conventional pressureless aluminium casting methods such as cold box, hot box and the like takes place by prebreaking and subsequent vibrating using vibrating tables, knocking, blowing out and other mechanical methods. Subsequently the castings are sand blasted, the blasting material comprising iron or quartz globules, in order to remove the remaining, adhering core material.

The mould and core production binder systems are mainly based on synthetic resins as binders for the sand employed. The organic binder components are largely prejudicial to health, so that at the workplace it is necessary to take precautions for drawing off the chemicals used (e.g. solvents or amines used as catalysts). Washing solutions occurring during the purification of the exhaust air have to be disposed of. The old or used sand produced in large quantities during coring must be disposed of in an expensive manner or is regenerated by pyrolysis and here again a health-prejudicial exhaust air is produced, so that the resulting washing solution must be once again expensively disposed of.

DE 195 49 469 discloses a water-soluble binder based on polyphosphate for the production of cores for pressureless aluminium casting methods and through the use of which the aforementioned disadvantages can be largely avoided.

Therefore the problem of the invention is to provide a method for coring water-soluble casting cores and also to provide a device enabling this method to be performed.

Particular attention is paid to the possible reuse of the old sand occurring during coring and also an economic and ecological treatment of the resulting waste water.

According to the invention the problem is solved by a method of the aforementioned kind in which the core sand is ejected from the castings by water jets. According to a preferred development of the inventive method the sand is ejected from the castings in a coring tank. Advantageously the castings having at least one casting core are introduced beforehand into a water-filled dissolving tank for partially dissolving the cores. According to a further development of the method the castings are residually desanded by movement in a water-filled residual desanding tank.

To solve the set problem the invention also provides a device of the aforementioned kind, which is characterized by a water jet device for ejecting the core sand from the castings.

According to a further development of the inventive device, the latter also has a coring tank for receiving castings during the expulsion of the moulding sand. The device according to the invention is preferably additionally provided with a water-filled dissolving tank for the partial dissolving of the moulding sand in the castings. According to a preferred development the device also has a water-filled residual desanding tank for flushing the moulding sand out of the castings.

The casting is immersed beforehand in a water-filled dissolving tank in order to partially dissolve the core. The partially dissolved core is then ejected from the casting by means of water jets in a coring tank. The residual sand remaining in difficultly accessible parts of the mould is then removed by a planned movement of the casting in a water-filled residual desanding tank.

It is advantageous for performing the method according to the invention for the individual plant parts necessary for the stepwise decoring of the casting to be connected to a conveying system having at least one conveyor belt in order to avoid unnecessary rearrangements of the castings.

The conveyor system provided for this purpose can comprise several individual conveyor belts or in a particularly advantageous construction can be in the form of a single conveyor belt.

In a preferred variant of the method, following casting, the casting is placed on a conveyor belt, which conveys it into the dissolving tank, it passes through said dissolving tank on the conveyor belt, is then raised thereon above the water level, conveyed to the coring station with water jet nozzles and, following coring, is conveyed to the dipping bath for residual desanding.

In the method, the conveyor belt or parts thereof are stopped at the processing or working stations or the conveying speed can be controlled in such a way as to be able to adapt the dwell time of the castings at the individual stations to the given requirements.

According to a particularly preferred development, the untreated castings are placed on the conveyor belt by a manipulator. From the equipment standpoint the manipulator can e.g. be a sensor-controlled gripping arm.

In the dissolving tank the casting core is partially dissolved in the water bath by taking up water. This partial dissolving can be brought about by clean or pure water alone as a result of the water-solubility of the binder. It is also possible to speed up the partial dissolving by the addition of a surfactant for reducing the surface tension and/or by adding a deaerator, which assists the expulsion of the remaining air in the core. Additionally or alternatively acid can be added.

The coring of the castings in each case takes place individually in order to exclude the introduction of sand from one mould into a neighbouring mould. As a result of the water-solubility of the binder, decoring takes place by water jets directed in targeted manner onto the casting. The water jet nozzles can be manipulated in all directions and the movement sequence thereof can be adapted in program-controlled manner to the given casting, which can ensure the coring of complicated castings, because the water jets also reach inaccessible corners in the interior of the casting.

According to a preferred development of the invention, movements of the water jet nozzles can be adapted to the castings in an at least partial, individual, program-controlled manner. This is particularly advantageous for small, difficultly accessible corners of the casting. According to a further development several water jet nozzles are combined into groupwise-controlled nozzle arrangements (nozzle assemblies), so as to permit the efficient coring of larger areas.

In order to completely core larger castings, in the coring tank is provided a translatory or rotary relative movement between the casting and the water jet nozzles. According to a further development this results from the fact that at least temporarily the casting is stopped and the water jet nozzles are moved or vice versa. According to a further development of the inventive device, the casting is placed in a rotation cage. The rotation cage preferably has a plurality of rollers, which run along substantially circular guide rails of the coring device.

According to a preferred embodiment, there are water jet nozzles with a differing geometry or corresponding nozzle assemblies and the water jet nozzles can be constructed as flat jet nozzles, full jet nozzles and/or full cone nozzles. The individual nozzle assemblies can be switched successively and can be active in time-displaced manner. However, it is also possible to activate different nozzle assemblies (nozzle geometries) simultaneously. By means of such a configuration there can initially be a large-area coring, e.g. by flat jet nozzles and then a following nozzle assembly, which is specifically constructed in accordance with the given casting (full jet, full cone jet), takes over the fine or precision coring. The jet pressure can be correspondingly adapted.

According to the method, following water jet coring, the casting is taken from the conveyor belt by a manipulator and transferred into a dipping bath for residual desanding.

The gripping arm can once again be a sensor-controlled gripping arm.

Particularly in the case of complicated moulds, it cannot be excluded that loose sand will have been deposited in inaccessible areas. This is now washed out by planned movements of the casting in the dipping bath and sinks by gravity onto the bottom of the dipping bath container. The casting movements performed take place in program-controlled manner in a horizontal, vertical and axial direction as a function of the requirements of the particular casting using the manipulator or gripping arm. The casting is then lifted out of the dipping bath and deposited on a removal station, which once again is brought about by the gripping arm in the same operation.

Both on the bottom of the dissolving tank, the coring tank and the dipping bath for residual coring a collection of old or used sand still contains binder residues takes place. This old sand is advantageously removed from the different tanks using a mud remover, such as is known from sewage sludge technology.

In a particularly advantageous development, the function of the sludge remover is taken over by the conveyor belt or individual conveyor belts. In this case the corresponding conveyor belt is provided with dogs on its surface. The castings are then conveyed on the top of the conveyor belt (holding function of the dogs), and on the bottom, which is guided along the particular tank bottom, the sand is conveyed by the dogs for discharge over the water surface. It is advantageous in this connection to design the corresponding parts of the conveyor system as sand-permeable conveyor belts, so as in this way to permit the depositing of the sand on the tank bottom.

In the case of a conveying system having only one conveyor belt, it is possible in this way to implement a common sand discharge for the complete coring device.

In another variant alternatively there can be a sand discharge by spiral conveyors, suction scrapers, sludge scrapers, etc.

According to a preferred variant, the discharged old sand is supplied to a sand washing device.

The sand washing device can be designed as a tank with a fine-meshed, sand-impermeable intermediate bottom, into which the old sand is introduced above said intermediate bottom. The sand washing device is filled with water.

Cleaning can take place by blowing compressed air under the intermediate bottom, optionally with interval operation, in order to bring about an efficient sand turbulence.

In the method the washed sand is also supplied to a dryer, which is constructed as a belt conveyor or continuous dryer. However, it is also conceivable to have a chamber drying, because this allows a more effective and more energy-saving drying.

The cleaned, dried sand can be used once again for the production of casting cores.

The waste water from the dissolving tank, the coring station, the dipping bath and the sand cleaning tank contains phosphates from the dissolved binder. There is no need to expensively dispose of this phosphate-containing waste water and it can instead be reused as a raw material in the chemical or fertilizer industry. To keep transportation and storage costs low, the waste water from the coring plant is fed to an evaporator unit, which transforms the waste water into a concentrate, so that the volume resulting therefrom is much smaller. The distillate produced can be directly resupplied to the coring device. For evaporation purposes it is e.g. possible to use a vapour compressor, e.g. in the form of a bubble evaporator, downflow evaporator or forced circulation evaporator, or alternatively a low temperature evaporator.

According to a preferred development of the invention, spray water occurring at the coring device or water vapour resulting from the coring of still hot castings is collected in an enclosure or recovered by condensation. For water vapour recovery advantageously the water vapour is cooled by means of the distillate from the evaporator unit, which is guided in cooling water hoses in walls of the enclosure. In this way additionally the distillate or the fresh or process water used (aqueous saline solution) is heated prior to reuse in water jet technology, which during decoring leads to an accelerated partial dissolving of binder bridges, so that the entire process can be more speedily performed.

According to a further development of the invention, the latter is provided with an optical detection system for detecting the casting geometry. Such a detection can e.g. be based on clouding or shadow formation of the casting when using suitable light sources, image recording devices (video, CCD) and image evaluating devices (microprocessors) and subsequently has a control influence on the coring process.

Further advantages and features of the invention can be gathered from the claims and the following description of embodiments of the invention relative to the attached drawings, wherein show:

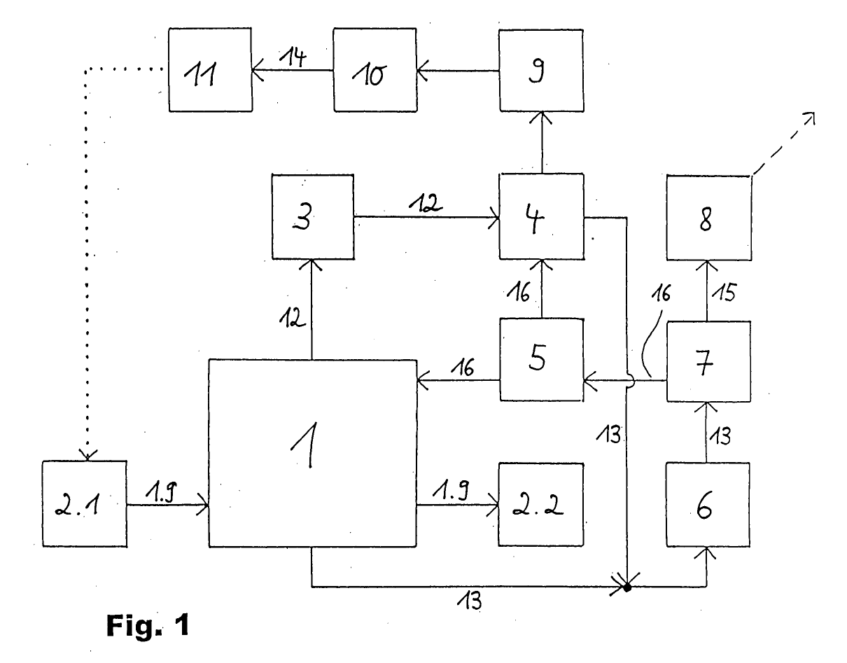

FIG. 1 A block diagram of a pilot plant as a device for performing the method according to the invention.

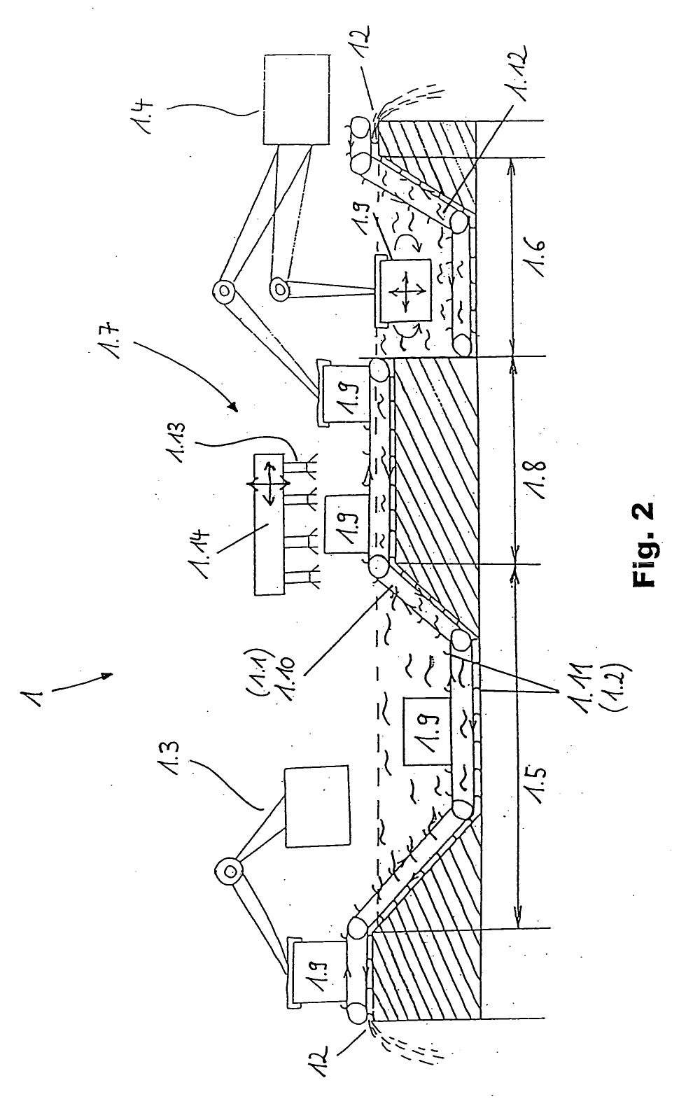

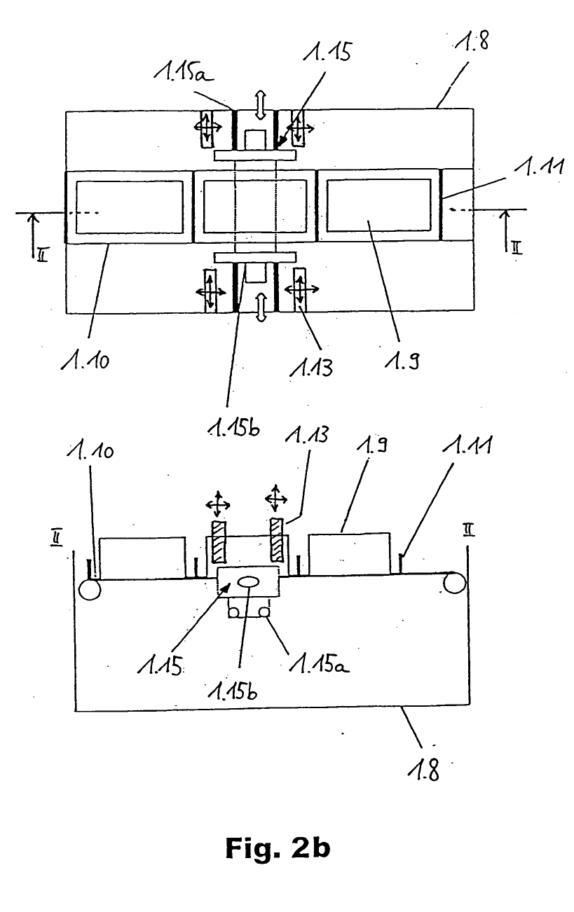

FIG. 2 A section through a development of the device illustrating the casting conveying path and the sequence of individual operations, as well as the sand discharge.

FIG. 2b A plan view and sectional view of a first embodiment of the water jet coring device.

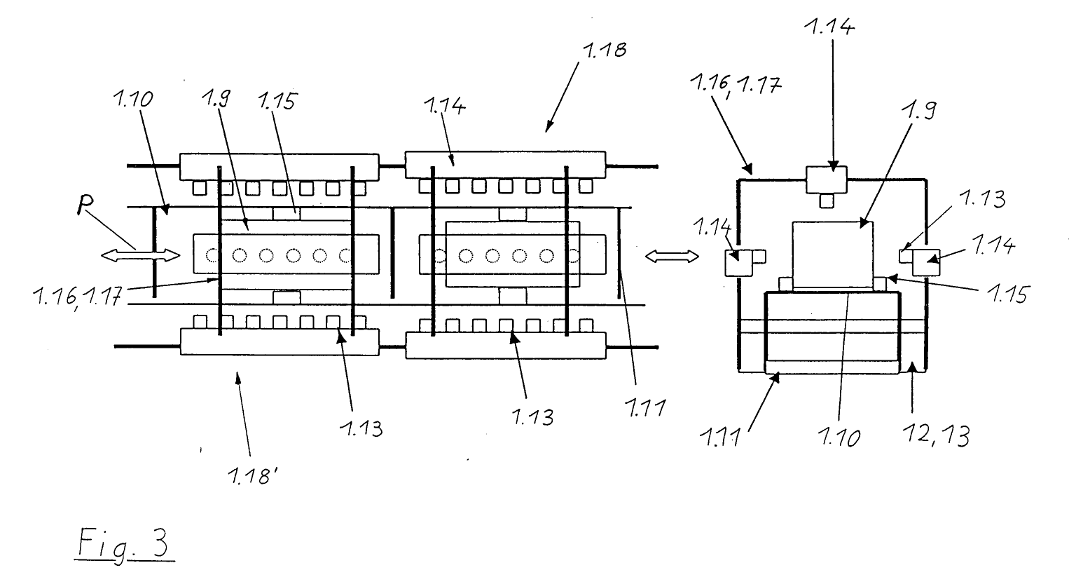

FIG. 3 A plan view and sectional view of a further water jet coring device embodiment.

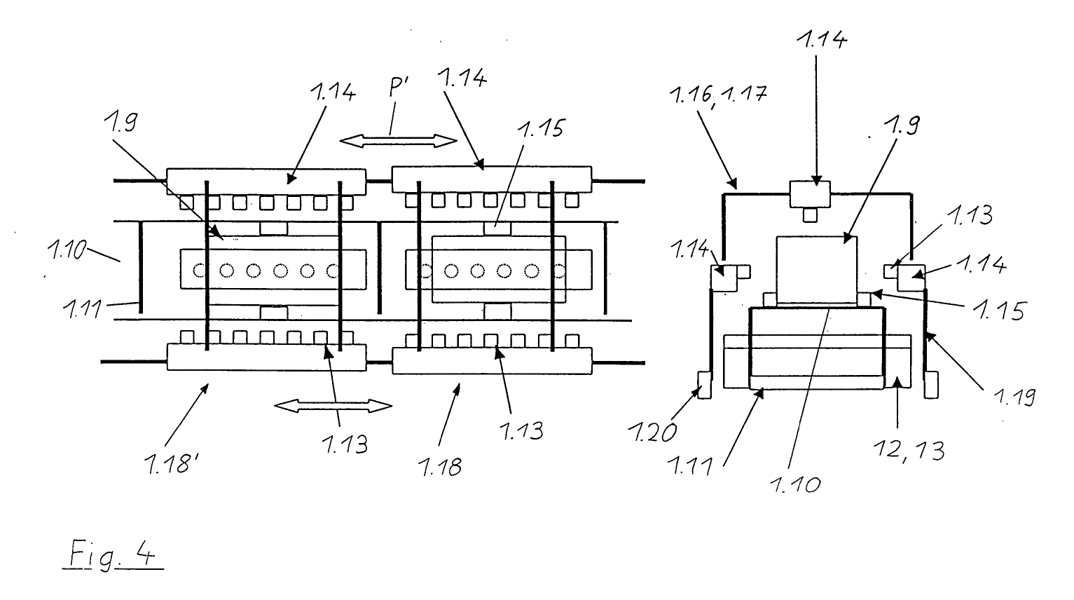

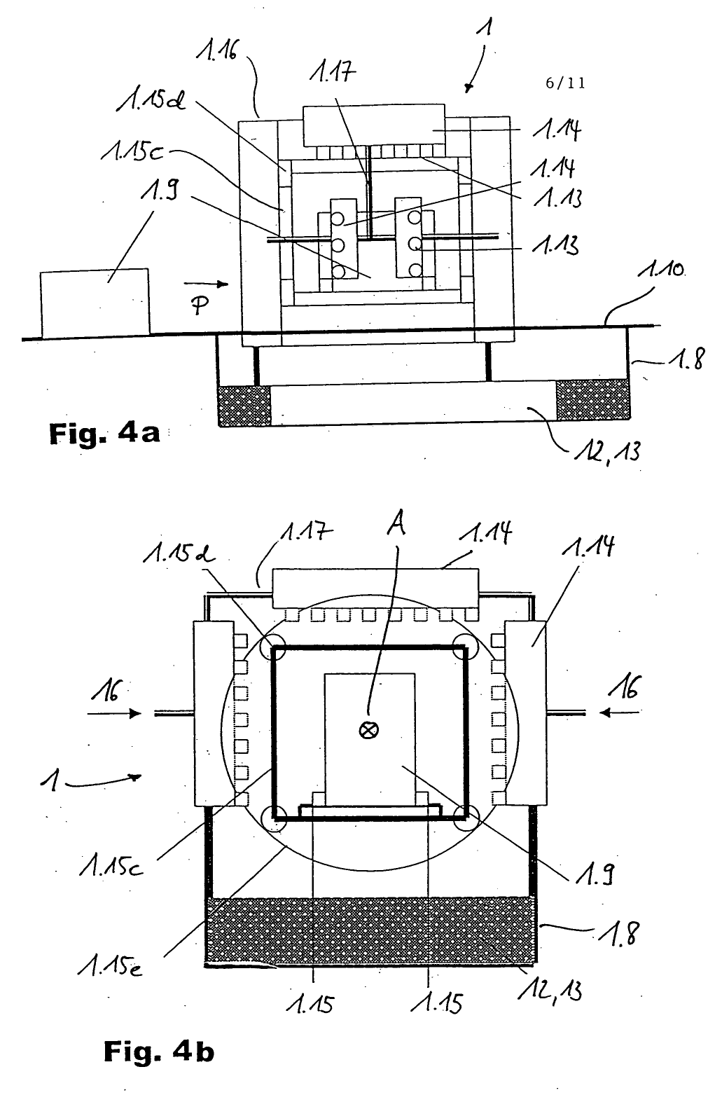

FIG. 4 A plan view and sectional view of a further water jet coring device embodiment.

FIG. 4a, b A side view and a front view of a further embodiment of the water jet coring device for the rotary movement of the castings.

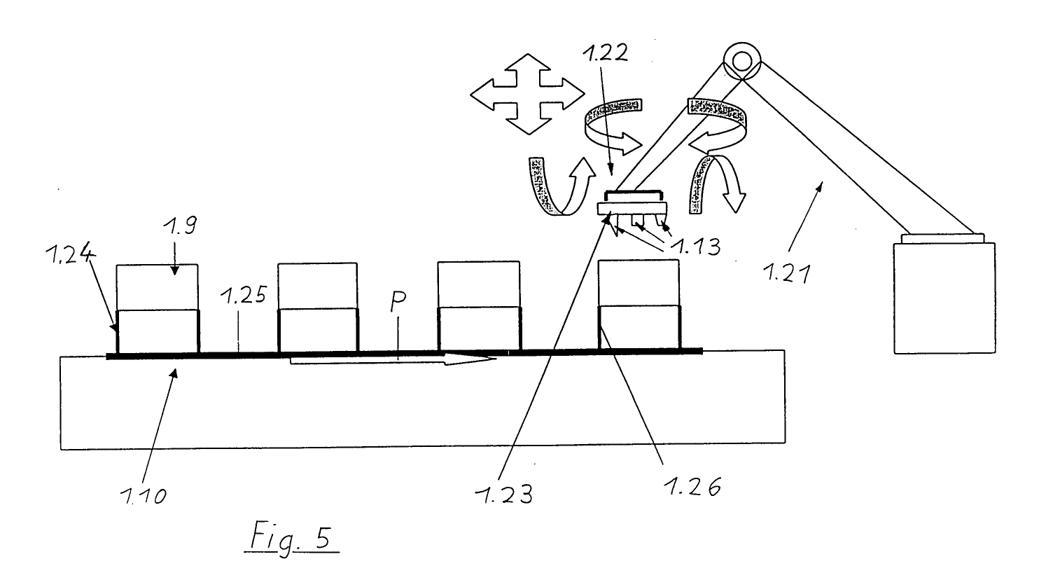

FIG. 5 A plan view of an inventive water jet coring device with a manipulator for casting coring.

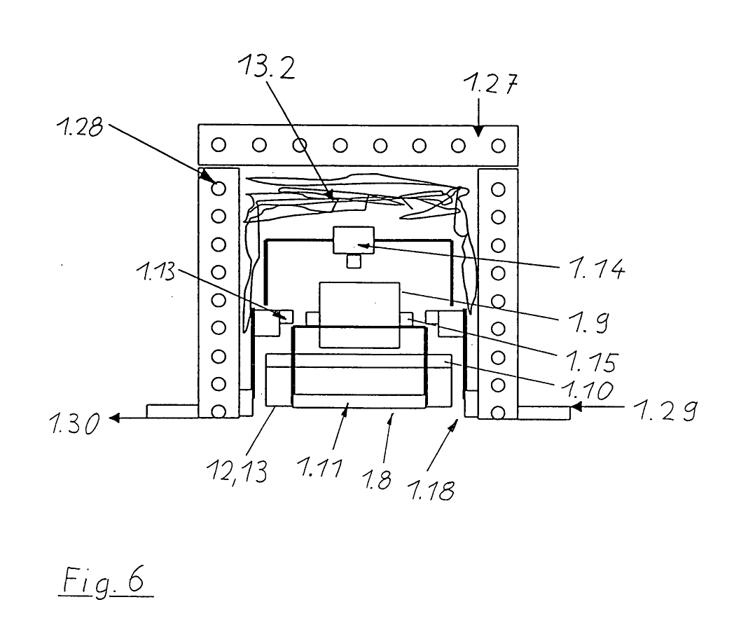

FIG. 6 A sectional view of an embodiment of the water jet coring device with an enclosure for heat and water vapour recovery.

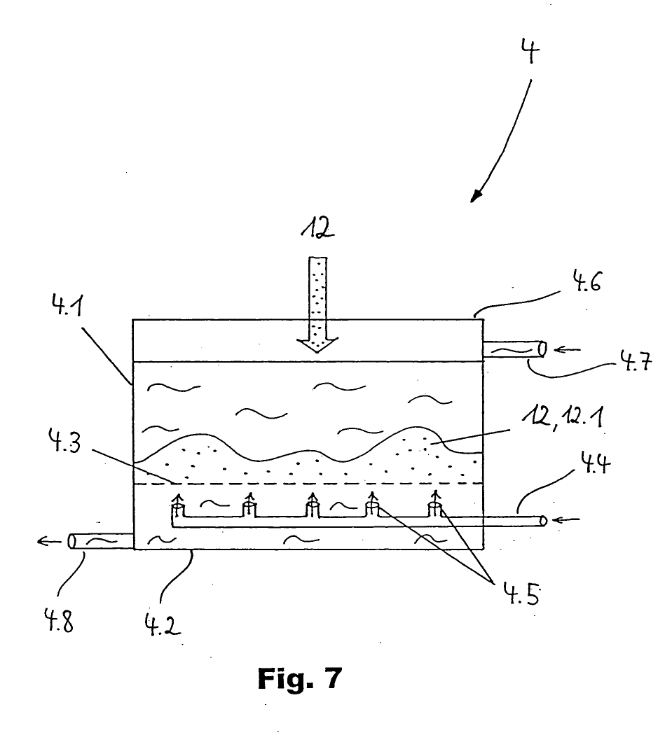

FIG. 7 A diagrammatic representation of the washing device for cleaning the old sand.

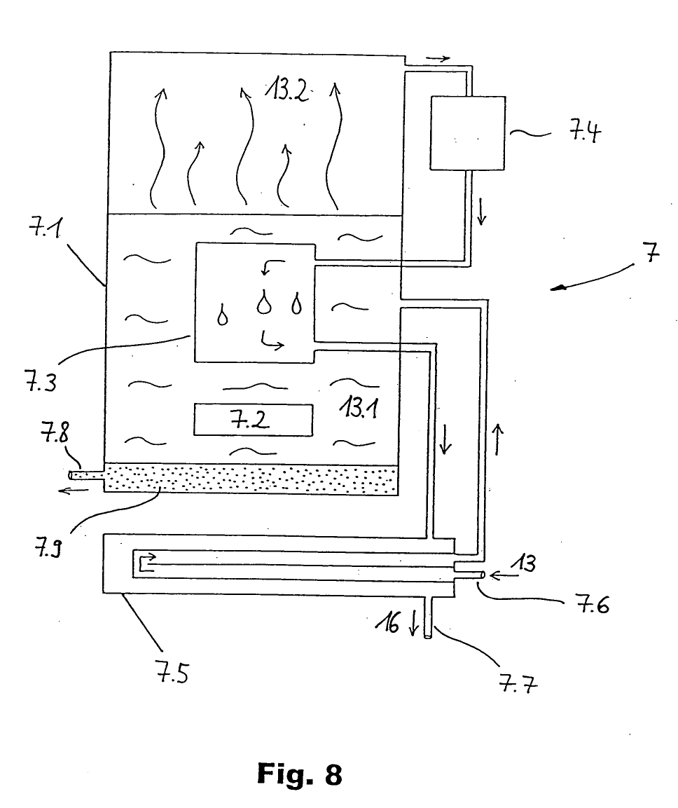

FIG. 8 A flow chart of the evaporator unit.

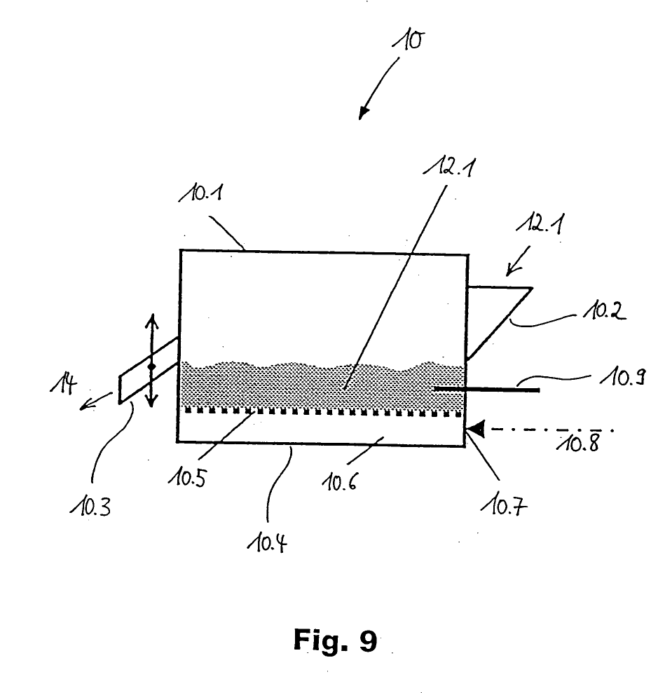

FIG. 9 A diagrammatic representation of the drying device.

In the form of a block diagram FIG. 1 shows a specific embodiment of a device for coring castings and in particular for performing the method according to the invention. The actual coring of the castings takes place in a coring device 1, which also incorporates a mud remover 1.1, 1.2. The coring device 1 is shown in greater detail in FIGS. 2 to 5.

In the immediate vicinity of a coring device 1 are provided lattice boxes 2.1, 2.2, which serve to receive untreated 2.1 and treated 2.2 castings. The device also has a sand collecting container 3, which is also located in the vicinity of the decoring device 1 and is positioned between the latter and a sand cleaning device 4. The sand cleaning device 4 and coring device 1 are connected by lines to a distillate container 5. Further lines lead from the coring device 1 and sand cleaning device 4 to a receiving tank 6 for a downstream evaporator unit 7 and from there to a concentrate container 8. The evaporator unit 7 is also connected to the distillate container 5. Downstream of the sand cleaning device 4, the device has a sand bunker 9 and a drying device 10 for washed sand and to this is connected a core making plant 11.

The method is performed in the following way: untreated castings are stored in the lattice box 2.1 and by means of a manipulator 1.3, e.g. in the form of a griping arm are supplied to the coring device 1. After coring has taken place a second manipulator 1.4 places the treated castings in the other lattice box 2.2.

Old or used sand 12 produced during coring and the dirty water 13 are separately recycled. The old sand 12 is transferred by means of the mud remover 1.1, 1.2 contained in the coring device 1 into the sand collecting container 3 and from there passes into the sand cleaning device 4 shown in greater detail in FIG. 7.

The cleaned sand is supplied to the drying device 10 via the sand bunker 9, which can e.g. take place by means of a feed screw. The cleaned, dried and therefore regenerated sand 14 is then reavailable in the core making plant 11. The drying device 10 is shown in greater detail in FIG. 9.

The waste water 13 is supplied by means of the receiving tank 6 to the evaporator unit 7, shown in greater detail in FIG. 8. In the latter the waste water 13 is reduced to a concentrate 15, which is stored in the separate container 8 and can be reused as a secondary raw material for the chemical industry. The distillate 16 passes into the intended container 5 and is consequently again available for the coring device 1 (specifically for the water baths 1.5, 1.6 contained therein and a water jet device 1.7) and for the sand washing device 4.

FIG. 2 shows the diagrammatic structure of an embodiment of the coring device 1. It has three essential partial devices, namely a water-filled dissolving tank 1.5, a water-filled residual desanding tank 1.6 and a coring tank 1.8, which are juxtaposed in a row. The dissolving tank 1.5 and coring tank 1.8 are connected to a conveyor system for the castings 1.9 to be cored and which in the embodiment shown comprises a sand-permeable conveyor belt 1.10 with dogs 1.11 for sand discharge on its surface. The conveyor belt 1.10 starts on the side of the dissolving tank 1.5 above the water surface and which is remote from the coring tank 1.8 and then passes over the bottom of the dissolving tank 1.5 and coring tank 1.8 and from there back again. The dogs 1.11 of the conveyor belt 1.10, in addition to the function of removing the washed out sand 12, also take over the function of a holding device for the castings 1.9 during conveying to the coring station. The residual desanding tank 1.6 has its own sand-permeable, dog-equipped conveyor belt 1.12, which also starts above the water surface, passes over the tank bottom and returns from there to the starting point. The coring device 1 also comprises two manipulators 1.3, 1.4 in the form of gripping arms arranged in such a way that a first manipulator 1.3 is located at the start of the dissolving tank 1.5, so that it reaches the part of the conveyor belt 1.10 running above the water surface. A second manipulator 1.4 is located at the end of the residual desanding tank 1.6, so that it reaches both the latter and also the end of the first conveyor belt 1.10 in the coring tank 1.8. The coring tank 1.8 has movable, program-controllable water jet nozzles 1.13, which in the embodiment shown, are arranged in groups in the form of nozzle assemblies 1.14.

The first manipulator 1.3, diagrammatically shown here as a sensor-controlled gripping arm, places the castings 1.9 on the first conveyor belt 1.10 on which they are introduced into the water-filled dissolving tank 1.5 (solvent temperature from room temperature to approximately 80øC.). Following an adequate partial dissolving time controllable by slowing down or speeding up the conveyor belt 1.10, the castings 1.9 enter the coring tank 1.8, where they are cored by means of the movable, program-controllable water jet nozzles 1.13 above the water level in the case of jet pressures of 2 to 6 bar.

Subsequently the second manipulator 1.4, shown here in the form of a second gripping arm, raises the castings 1.9 from the conveyor belt 1.10 and for residual desanding dips them by a planned movement into a water-filled residual desanding tank 1.6. After residual desanding, the castings 1.9 are removed from the residual desanding tank 1.6 by manipulator 1.4 and are set down for further working.

The discharge 12 of the sand which has collected on the bottoms of the tanks 1.5, 1.6 and 1.8 is brought about by the mud or sludge removal function of the conveyor belts 1.10 and 1.12. With their surfaces equipped with dogs 1.11, the conveyor belts are so passed over the tank bottoms that the old sand 12 is lifted above the tank edge and is in this way discharged.

In a plan view and a sectional view, FIG. 2b shows further details of the water jet device in the coring tank 1.8. For coring the castings 1.9 laterally movable water jet nozzles 1.13 are also provided. The conveyor belt 1.10 provided with dogs 1.11 can be speed-controlled in such a way as to achieve an optimum coring. The speed is to be determined empirically.

The coring tank 1.8 also has a clamping device 1.15 as a holding device for the castings 1.9 during the coring phase, which is fixed to the outer wall of the tank at 1.15a and incorporates one or more clamping plates 1.15b.

FIGS. 3 and 4 in each case show a plan view (left) and a sectional view (right) further embodiments of a water jet coring device according to the invention.

FIG. 3 illustrates a principle for the use of water jet technology for coring castings 1.9 with a mobile casting 1.9 on a conveyor belt 1.10 and fixed arrangements of water jet nozzles 1.13 (nozzle assemblies 1.14). The nozzle assemblies 1.14 are linear arrangements of a plurality of water jet nozzles 1.13, arranged on a nozzle jet frame 1.16 laterally and above the castings 1.9 positioned on the conveyor belt 1.10. The nozzle jet frame 1.16 has a closed U-shaped design above the casting 1.9 and is provided with connecting lines 1.17 for fresh or process water (distillate 16 or aqueous saline solution with a concentration up to 13%, preferably up to 8.5% and a pH of 7 to 12) used for coring the castings 1.9.

The arrangement of in each case three nozzle assemblies 1.14 on a nozzle jet frame 1.16 is referred to as a nozzle jet set 1.18, 1.18′. It can be seen in the left-hand part of FIG. 3 that a plurality of such nozzle jet sets 1.18, 1.18′ can be located along the conveyor belt 1.10 movable in the direction of the double arrows P, the nozzle assemblies 1.14 of the particular nozzle jet set 1.18, 1.18′ having different nozzle types. Thus, the front nozzle jet set 1.18 in the conveyor belt movement direction e.g. has flat jet nozzles, which form a first cleaning or coring stage (active on a large area). The following nozzle jet set 1.18′ in the conveyor belt movement direction forms a second cleaning or coring stage and for this purpose has e.g. full jet and full cone nozzles with which a planned small scale coring of the castings 1.9 is possible. The nozzle material is chosen as a function of the sought durability and chemical stability. It is e.g. possible to have nozzles made from polymer, brass or high grade steel.

FIG. 4 shows in a representation corresponding to FIG. 3 another embodiment in which the nozzle assemblies 1.14 with water jet nozzles 1.13 are placed on mobile nozzle jet frames 1.18, 1.18′. For this purpose the latter are provided in the lower area, i.e. at the ends 1.19 of their free legs with wheels 1.20 on which they are movable along the conveyor belt 1.10 with the castings 1.9 in the direction of the double arrows P′ at a speed which is to be empirically established. In the same way as with the embodiments of FIG. 3, this permits a multistage coring process for the castings 1.9.

Additionally or alternatively to the horizontal movements of FIGS. 3 and 4 represented by the double arrows P and P′, the castings 1.9 and/or the nozzle assemblies 1.18, 1.18′ can also move vertically (perpendicular to the plane of the conveyor belt 1.10). A separate, not shown lifting device is provided for the castings 1.9 for this purpose.

FIGS. 4a and 4b show a further development of the inventive coring device constructed for the rotary movement of the castings.

For this purpose the coring device 1 has, in addition to the embodiments of FIGS. 3 and 4, a rotation cage 1.15c, which has an essentially parallelepipedic construction (FIG. 4b) and which is guided in rotary manner within the nozzle jet frame 1.16 by means of rollers 1.15d located at its corners and on parallel, circular guide rails 1.15e, whereof only one can be seen in FIG. 4a, b. In the embodiment shown, the rotation cage 1.15c is rotatable about an axis A parallel to the plane of the conveyor belt 1.10 and which is shown in FIG. 4b (therein perpendicular to the paper plane).

The coring process by a rotary movement of the casting takes place as follows:

Firstly the casting 1.0 to be cored is conveyed by means of the conveyor belt 1.10 in the direction of arrow P to the rotation cage 1.15c. With the aid of e.g. not shown light barriers, a precise positioning of the casting 1.9 below the rotation cage 1.15c is determined. Then and using a not shown lifting device, the casting 1.9 is lifted into the rotation cage 1.15c and is fixed thereby the clamping device 1.15.

This is followed by an initiation of the rotation of the casting 1.9 and also coring using the water jet nozzles 1.13. The rotation speed must be adapted to the coring operation. The rotary movement can be performed clockwise and counterclockwise. Through such a rotation of the casting 1.9 it is possible to reach all the surfaces of the casting 1.9 with the water jets. In addition, it is easier to reach undercuts in the casting 1.9 and the 360ø rotary movement permits a more effective mud removal.

Rotation is implemented with parallel guide rails 1.15e (two in the case of the embodiment shown) and the rotation cage 1.15c located therein, which is connected by means of four rotary-mounted rollers 1.15d to the rails 1.15e.

This coring principle can be combined with the heat and water vapour recovery enclosure described hereinafter relative to FIG. 6 and which is not shown so as not to overburden representation. The arrangement of the nozzle assemblies 1.13 (vertical or horizontal arrangement) with respect to the casting must be determined empirically. The nozzle geometries used correspond to the coring principles described hereinbefore.

FIG. 5 shows a further water jet technology use principle for the coring of castings using a manipulator.

For this purpose a further manipulator 1.21 is positioned in the vicinity of the conveyor belt 1.10 and at its distal end 1.22 of its arms carries a nozzle jet head 1.23, which in the embodiment shown has water jet nozzles 1.13 in different forms, e.g. flat jet, full jet and full cone nozzles. On the conveyor belt 1.10 moved in the direction of the arrow P is provided an upright means 1.24 for receiving the castings 1.9. It is essentially in the form of a plate 1.25 placed flat on the conveyor belt 1.10 and which has on its top a plurality of vertical supports 1.26, on which the castings 1.9 rest with a spacing from the plate 1.25, so that they have all-round accessibility and consequently coring is possible from all sides.

The coring of the castings 1.9 located on the conveyor belt 1.10 (upright means 1.24) and which move past the manipulator 1.21 in the direction of the arrow P takes place by a punctiform, program-controlled following or tracking of the castings 1.9 by the manipulator 1.21 and, as required, the different water jet nozzles 1.13 on the nozzle jet head of the manipulator are used. The different movement possibilities of the manipulator 1.21 in all directions in space are represented by the arrows in the upper part of FIG. 5.

In order to reduce water losses during the coring of hot castings when using the aforementioned water jet technology, in a preferred development of the invention use is made of a water and heat recovery system in a water jet coring plant, as illustrated in FIG. 6.

FIG. 6 is a sectional view through a construction of the device with a mobile nozzle jet frame 1.18 essentially corresponding to the sectional view of FIG. 4. Around the coring device is provided an enclosure 1.27 with a U-shaped cross-section, which completely surrounds the coring device and is at least largely made from a good heat conducting material, e.g. a metal. Water hoses 1.28 are located within the wall of the enclosure 1.27 which have a helical or meandering configuration and extend substantially into and out of the drawing plane.

By means of a feed line 1.29 and a discharge line 1.30 in lines 1.28 supply takes place of the distillate 16 from the evaporator unit 7, fresh water or a solution of water and salt (process water).

When using water jet technology for coring the generally hot castings 1.9 (casting temperature up to 450øC., temperature range for die and sand casting), within the enclosure 1.27 there is a formation of water vapour 13.2, which as a result of the-temperature difference with respect to the walls of the enclosure 1.27 condenses on the latter, so that water losses during coring are drastically reduced. The condensate can subsequently be supplied to the coring tank 1.8 and further treated in the manner described hereinbefore. The heated distillate 16 leaves the enclosure through the outlet 1.30 and is subsequently used for coring castings 1.9 and as a result of the increased water temperature a faster partial dissolving of binder bridges is brought about, so that coring can take place more rapidly.

The enclosure 1.27 with the water-carrying hoses 1.28 consequently functions in accordance with the principle of a heat exchanger through which part of the thermal energy used during the casting process is recovered and employed for accelerated coring of the castings.

The diagrammatic representation of FIG. 7 shows the sand washing device 4 with the aid of which the sand 12 produced during coring can be freed from binder residues. In the embodiment shown it has a tank 4.1, which is provided at roughly ⅔ of its depth with a fine-meshed, sand-impermeable intermediate bottom 4.3 arranged parallel to the tank bottom 4.2. Below the intermediate bottom 4.3 is provided a compressed air line 4.4 extending parallel to the tank bottom 4.2 and covering most of the tank extension and which is provided at regular intervals with upwardly directed openings 4.5, i.e. in the direction of the intermediate bottom 4.3. In the vicinity of the upper tank rim 4.6, the tank 4.1 also has a feed line for fresh water 4.7 and on the tank bottom 4.2 an outlet 4.8 for dirty water 13.

The old sand 12 is introduced above the fine-meshed, sand-impermeable intermediate bottom 4.3 into the washing device 4 and the latter is filled with fresh water. Turbulent motion of the sand 12 is brought about by compressed air blown in below the intermediate bottom 4.3 and which can rise upwards through the latter.

By means of the dirty water outlet 4.8 on the bottom of the sand washing device 4, waste water 13 can be supplied to the evaporator unit 7 shown in FIG. 1.

FIG. 8 is a flow chart for an evaporator unit with vapour compressor. The evaporator unit 7 has an evaporator 7.1 in the form of a tank-like container, which is provided with a starting heater 7.2. The interior of the evaporator 7.1 is in contact with a condenser 7.3, which can e.g. be constructed as a plate heat exchanger. The evaporator 7.1 and condenser 7.3 are connected by means of a vapour compressor 7.4, i.e. an oval gear vacuum pump. The evaporator unit 7 also has a heat exchanger in the form of a preheater/distillate cooler 7.5. The preheater 7.5 has a dirty water intake 7.6 and is connected to the interior of the evaporator 7.1. The distillate cooler 7.5 has an outlet 7.7 for the distillate 16 and is connected to the condenser 7.3. On the bottom of the evaporator 7.1 is provided an outlet 7.8 for the concentrated waste water in sump 7.9.

At the start of the process the waste water 13 to be evaporated is sucked through the preheater/distillate cooler 7.5 into the evaporator 7.1. This takes place by means of the vacuum pump constructed as a vapour compressor 7.4 and which ensures a vacuum by sucking off the air initially present in the evaporator 7.1. The entering waste water 13 is heated by the compressed and therefore heated air passed through the condenser 7.3. Additionally, at the start of the process, the heater 7.2 can be connected until the waste water 13 of boils. The rising water vapour 13.2 is sucked off by the evaporator 7.4, brought to normal pressure and condenses in condenser 7.3, the released heat being delivered to the evaporator content 13.1. The distillate 16 leaves the device via the preheater/distillate cooler 7.5 and supplies part of its thermal energy to the inflowing waste water 13.

The concentrated waste water in sump 7.9 can be drained off into a not shown container as soon as it has reached the desired final concentration and then a new evaporation cycle commences.

FIG. 9 shows the drying device 10 for washed core material 12.1 in the specific form of a fluid bed dryer. The dryer housing 10.1 is a sheet steel welded structure and has a sand feed hopper 10.2 and a vertically adjustable sand outlet 10.3, whose vertical position determines the layer height of the sand 12.1 in the drying device 10. In the lower area of the housing 10.1 and parallel to the housing bottom 10.4 is provided a nozzle bottom 10.5, which is constructed as a sheet metal plate with holes for threaded air nozzles (not shown). An air chamber 10.6 is located below the nozzle bottom 10.5. The air nozzles are constructed in such a way that with the aid thereof air can be passed upwards from the air chamber 10.6 through the nozzle bottom 10.5 but, even when stationary, no solids can pass from above through the nozzle bottom 10.5 into the air chamber 10.6. In the vicinity of the air chamber 10.6 the housing 10.1 has an opening 10.7 for blowing in heated drying air 10.8. A thermocouple 10.9 is also provided for measuring the sand temperature.

The sand 12.1 to be dried is introduced into the housing 10.1 above the nozzle bottom 10.5. Air 10.8 heated to roughly 400øC. is blown into the air chamber 10.6 and passed via the nozzle bottom 10.5 into the sand bed 12.1. The dryer air 10.8 flows through the sand bed 12.1 in such a way that it brings about a detachment of the individual sand particles from the layer, but does not give rise to a pneumatic transport of the sand. Thus, there is an intensive intermixing of the sand particles without the discharge thereof from the layer 12.1, which can also be referred to as a fluid bed or fluidized filling layer. By means of the thus maximized contact surface between the solid and gas, i.e. sand 12.1 and dryer air 10.8, the heat content of the air is rapidly delivered to the sand 12.1, so that the water evaporates. The temperature sensor 10.9 monitors the sand temperature, whose rise indicates an inadequate introduction of sand. The dried sand 14 leaves the chamber 10.1 via the sand outlet 10.3.

The following influencing factors are of decisive importance for the coring process and are controlled or expressly taken into account within the scope of the proposed method and the above-described device:

type of solvent (water);

as desired, fresh water (in the neutral pH range) or process water;

solvent viscosity;

when using process water (pH 7 to 12) concentration of the solution up to 13%, preferably up to 8.5%;

solvent pressure 2-6 bar;

solvent jet (dependent on nozzle form);

nozzle material, as a function of the sought durability and chemical stability (e.g. polymer, brass, high grade steel);

solvent temperature (room temperature to 80øC.);

casting temperature (room temperature to 450øC.), temperature range for mould and sand casting;

casting geometry (use of an optical detection system);

duration of coring process;

conveyor belt and nozzle jet frame speeds (to be determined empirically).

List of Reference Numerals

1 coring device

1.1/1.2 mud remover

1.3/1.4 manipulator

1.5 water bath (dissolving tank)

1.6 water bath (residual desanding tank)

1.7 water jet device

1.8 coring tank

1.9 casting

1.10 conveyor belt

1.11 dog

1.12 conveyor belt

1.13 water jet nozzle

1.14 nozzle assembly

1.15 clamping device

1.15a fixture

1.15b clamping plate

1.15c rotation cage

1.15d roller

1.15e guide rail

1.16 nozzle jet frame

1.17 connecting line

1.18/1.18′ nozzle jet set

1.19 frame end

1.20 wheel

1.21 manipulator

1.22 distal end (of the arm of 1.21)

1.23 nozzle jet head

1.24 upright means

1.25 plate

1.26 support

1.27 enclosure

1.28 water line

1.29 feed line

1.30 discharge line

2.1/2.2 lattice box

3 sand collecting container

4 sand washing device

4.1 tank

4.2 tank bottom

4.3 intermediate bottom

4.4 compressed air line

4.5 opening

4.6 tank rim

4.7 fresh water supply line

4.8 dirty water drain

5 distillate container

6 receiving tank

7 evaporator unit

7.1 evaporator

7.2 starting heater

7.3 condenser

7.4 vapour compressor

7.5 heat exchanger

7.6 dirty water feed

7.7/7.8 drain

7.9 sump

8 concentrate container

9 sand bunker

10 drying device

10.1 dryer housing

10.2 sand introduction hopper

10.3 sand outlet

10.4 housing bottom

10.5 nozzle bottom

10.6 air chamber

10.7 opening

10.8 drying air

10.9 thermocouple

11 core making plant

12 old sand

12.1 washed sand

13/13.1 dirty water

13.2 water vapour

14 regenerated sand

15 (waste water) concentrate

16 distillate

A rotation axis

P, P′ movement direction

1. Method for coring water-soluble casting cores made from sand from castings, the core sand being ejected from the castings by water jets, wherein washing water from the sand washing device and/or the coring device is supplied to an evaporator unit.

2. Method according to claim 1, wherein the sand is ejected from the castings in a coring tank.

3. Method according to claim 1, wherein the castings having at least one casting core are previously introduced into a water-filled dissolving tank for the partial dissolving of the casting core.

4. Method according to claim 1, wherein the castings are residually desanded by movement in a water-filled residual desanding tank.

5. Method according to claim 1, wherein the conveying of the castings between the dissolving tank, coring tank and residual desanding tank takes place by means of a conveyor system having at least one conveyor belt.

6. Method according to claim 2, wherein the sand is washed out and is discharged by means of a mud remover from the residual desanding tank and/or coring tank and/or dissolving tank.

7. Method according to claim 5, wherein the conveyor belt or at least one of the conveyor belts is slowed down or stopped while there are castings in the dissolving tank, the coring tank or residual desanding tank.

8. Method according to claim 1, wherein the partial dissolving of the core is accelerated by adding a surfactant and/or a deaerator and/or acid to the dissolving tank.

9. Method according to claim 5, wherein the dwell time in the dissolving tank necessary for the partial dissolving of the core is brought about by slowing down the conveying rate or stopping the corresponding conveyor belt.

10. Method according to claim 1, wherein water jet coring takes place separately for each individual casting in order to prevent sand being introduced into other castings.

11. Method according to claim 1, wherein coring takes place by water jets directed in targeted manner onto the casting.

12. Method according to claim 11, wherein the casting is at least partly cored by means of individual water jet nozzles adaptable in program-controlled manner to the casting, e.g. which are locally pressure-controlled.

13. Method according to claim 11, wherein the casting is cored at least partly by means of individual nozzles controlled in groups (nozzle assembly).

14. Method according to claim 11, wherein the castings and water jet nozzles are moved in translatory manner relative to one another during coring.

15. Method according to claim 14, wherein the castings is at least partly moved past the water jet nozzles.

16. Method according to claim 14, wherein the water jet nozzles are at least partly moved past the casting.

17. Method according to claim 11, wherein, during coring, the castings and water jet nozzles are moved relative to one another in rotary manner.

18. Method according to claim 11, wherein, for coring, water jet nozzles with different geometries are used.

19. Method according to claim 11, wherein at least a plurality of water jet nozzles are moved and operated by a manipulator.

20. Method according to claim 1, wherein, during coring, the casting is held by means of a clamping device located in the coring tank.

21. Method according to claim 5, wherein the untreated castings are placed by a manipulator on the conveyor belt or the first of several conveyor belts.

22. Method according to claim 5, wherein the castings subject to water jet actions are taken by a manipulator from the corresponding conveyor belt and transferred into the residual desanding tank, where program-controlled by the same manipulator and as a function of the nature of the casting they are moved in all directions in space and from which they are removed again by the same manipulator.

23. Method according to claim 5, wherein the conveyor belt or at least one of the individual conveyor belts is guided with its top along the bottom of the dissolving tank, coring tank and/or residual desanding tank in such a way that the washed out sand is discharged from the tank by dogs present on the surface of the conveyor belt or belts.

24. Method according to claim 1, wherein the discharged old sand is supplied to a sand washing device.

25. Method according to claim 24, wherein the old sand is introduced into the sand washing device above a fine-meshed, sand-impermeable intermediate bottom, said device is filled with fresh water and the sand is cleaned by blowing compressed air below the intermediate bottom.

26. Method according to claim 25, wherein the cleaning process is supported by interval switching of the compressed air supply to bring about an optimum turbulent motion of the sand.

27. Method according to claim 1, wherein distillate from the evaporator unit is resupplied to the coring device and/or sand washing device and the waste water concentrate is available as secondary raw material.

28. Method according to claim 24, wherein the washed sand is supplied to a drying device.

29. Method according to claim 28, wherein the dried sand is used for producing new casting cores.

30. Method according to claim 1, wherein at least spray water arising at the coring device or resulting water vapour is collected in an enclosure or recovered by condensation.

31. Method according to claim 30, wherein for water vapour recovery the resulting water vapour is cooled by means of the distillate from the evaporator unit.

32. Method according to claim 1, comprising an optical detection of the casting geometry.

33. Device for coring water-soluble casting cores made from sand, particularly according to the method of claim 1, having a water jet device for ejecting moulding sand from the castings, comprising an evaporator unit for the waste water occuring in dissolving tank, coring tank, residual desanding tank and sand washing device.

34. Device according to claim 33, comprising a coring tank for receiving the castings during the ejection of the mouding sand.

35. Device according to claim 33, comprising a water-filled dissolving tank for the partial dissolving of the moulding sand in castings.

36. Device according to claim 33, comprising a water-filled residual desanding tank for flushing moulding sand out of the castings.

37. Device according to claim 33, wherein the dissolving tank, coring tank and residual desanding tank are interconnected with at least one conveyor belt.

38. Device according to claim 33, wherein the dissolving tank, decoring tank and residual desanding tank are linked by a conveyor system having several independent conveyor belts.

39. Device according to claim 37, wherein the conveyor belt or at least one of the individual conveyor belts is constructed in sand-permeable manner.

40. Device according to claim 37, wherein the conveyor belt or at least one of the individual belts has a controllable conveying speed.

41. Device according to claim 37, comprising a manipulator for placing the untreated castings on the conveyor belt or the first partial belt of the conveyor system.

42. Device according to claim 33, comprising a manipulator for transferring castings which have been subject to water jet action from the coring tank into the residual desanding tank, for program-controlled movement of the castings in the residual desanding tank and for removing the castings from the residual desanding tank.

43. Device according to claim 34, wherein the dissolving tank and/or coring tank and/or residual desanding tank have at least one mud remover.

44. Device according to claim 43, wherein the mud remover or removers are constructed as spiral conveyors, suction scrapers, sludge scrapers or the like.

45. Device according to claim 37, wherein the conveyor belt or at least one of the individual conveyor belts has on its surface dogs for sand discharge purposes and/or as a holding device for the castings during conveying to the water jet device in the coring tank.

46. Device according to claim 34, wherein the coring tank has a clamping device for the castings during the coring phase.

47. Device according to claim 33, wherein the water jet device has water jet nozzles, which can be directed in targeted manner onto the castings for coring.

48. Device according to claim 47, wherein movements of the water jet nozzles can be at least partly adapted in individually program-controlled manner to the castings.

49. Device according to claim 47, wherein several water jet nozzles are combined into nozzle arrangements (nozzle assemblies) controlled in groups.

50. Device according to claim 47, comprising a translatory relative movement between casting and water jet nozzles.

51. Device according to claim 47, comprising a rotary relative movement between casting and water jet nozzles.

52. Device according to claim 50, wherein at least temporarily the casting is held and the water jet nozzles are moved or vice versa.

53. Device according to claim 51, wherein the casting is placed in a rotation cage.

54. Device according to claim 53, wherein the rotation cage has a plurality of rollers, which run on substantially circular guide rails of the coring device.

55. Device according to claim 47, comprising water jet nozzles of different geometry or corresponding nozzle assemblies.

56. Device according to claim 55, wherein the water jet nozzles are constructed as flat jet nozzles, full jet nozzles and/or full cone nozzles.

57. Device according to claim 47, wherein at least a plurality of water jet nozzles is located on one manipulator and can be moved by the latter around the casting.

58. Device according to claim 57, wherein the casting is received in an upright means for coring from all sides.

59. Device according to claim 33, comprising a sand washing device in the form of a tank with a fine-meshed, sand-impermeable intermediate bottom, a device located below it for blowing in compressed air, a feed line for fresh water and a discharge line for waste water.

60. Device according to claim 33, wherein the evaporator unit is constructed as a bubble evaporator, downflow evaporator, forced circulation evaporator or low temperature evaporator.

61. Device according to claim 59, comprising a drying device for the washed old sand.

62. Device according to claim 61, wherein the drying device is constructed as a belt conveyor, continuous or chamber dryer.

63. Device according to claim 33, comprising an enclosure, at least surrounding the coring device, for collecting spray water and/or for recovering water vapour.

64. Device according to claim 63, wherein the enclosure can be cooled by means of the distillate from the evaporator unit.

65. Device according to claim 64, comprising cooling water hoses in walls of the enclosure.

66. Device according to claim 33, comprising an optical detection system for detecting the casting geometry.
